(19) United States
(12) Patent Application Publication
(10) Pub. No.: US 2012/0257581 A1
(43) Pub. Date: Oct. 11, 2012

(54) Femto Cluster Architecture for WCDMA and LTE

(75) Inventor: Debjani De, Bangalore (IN)

(73) Assignee: CONTINUOUS COMPUTING INDIA PRIVATE LIMITED, Bangalore (IN)

(21) Appl. No.: 13/084,164

(22) Filed: Apr. 11, 2011

(51) Int. Cl. H04W 72/04; H04W 4/00

(52) U.S. Cl. 370/329; 370/328

(57) ABSTRACT

Embodiments disclosed herein provide a system and method of providing a distributed architecture for the Layer 2 and Layer 3 devices in a wireless communication network. Instead of using a single device with functionalities of Layer 2 and Layer 3 layers, the proposed system uses a distributed architecture for Layer 2 and Layer 3 devices where a single Layer 3 device controls multiple Layer 2 devices and the Layer 2 devices form a mesh network. This architecture provides multiple channels for communication between Layer 3 and communication devices and hence avoids congestion in channels while multiple devices communicate with Layer 3 simultaneously. A central server is employed to control Layer 3 devices and corresponding Layer 2 devices. The server maintains a database of parameters allocated to Layer 2 devices. The server ensures distribution of unique values of parameters to the associated Layer 2 devices.

### TECHNICAL FIELD

The embodiments herein relate to Femto cluster devices and, more particularly, to providing separate hardware for Layer 2 and Layer 3 devices in femto clusters,

### BACKGROUND

The Open System Interconnection model otherwise called as OSI model is a way of sub-dividing communication system into different layers where each layer is a collection of specific functionalities. The layers are designed in such a way that each layer provide services to the layer above it and receive services from the layer below it. OSI layer has 7 layers and the layers are namely Physical, Data link, Network, Transport, Session, Presentation and Application layer.

Layer 2 refers to Data ink layer. Data link layer is a protocol layer which manages data transfer between nodes in wide area networks or between nodes on the same local area network. Data Link layer provides data transfer across the physical layer. The functions carried out by data link layer include encapsulation of network layer data packets into frames, frame synchronization, error control, flow control, management of MAC (multiple Access Control) and so on.

Layer 3 refers to Network Layer. Network layer provide functional and procedural means of transferring variable length data sequences from a source to destination host via one or more networks. Along with transfer of data across networks, the network layer also manages quality of service functions. Other major functions carried out by the network layer include connectionless communication, host addressing, message forwarding etc.

The present WCDMA and LTE FAP communication systems use a single device comprising the functionalities of Layer 1 through Layer 3. Wireless communication devices will be associated with the L1 layer and the devices always have to communicate with the L3/L2 layer through the L1 layer. There is a limit to the total number of devices that can be associated with each L1 layer in a device and when more devices are to be supported, we need to employ more cells. Also, the data and control flow from and to L3 layer happens through L2/L1 always. As a result, in case of such networks, when the network has to support more data simultaneously, congestion may occur in the network which in turn results in loss of data and also causes delay in delivery of the data. From the communication point of view, loss of data as well as delay in delivery of data is critical. Also in communication systems, the data is sent in the form of packets. If any of these packets get lost, it will affect the entire data and in such a case the accuracy of data delivery is seriously affected.

Due to the aforementioned reasons present day systems that employ means for communication over the integrated L1 through L3 layers are not effective.

### SUMMARY

In view of the foregoing, an embodiment herein provides a femto cell system comprising at least one layer 3 device and at least one layer 2 device. The Layer devices have Layer 1 integrated. The femto cell system comprises of the layer 3 device that is configured for checking if the Layer 2 device that is in its vicinity has the parameters configured, configuring power control parameters of the Layer 2 device and allocation of resources to the Layer 2 device based on the power control parameters, provide RRM, SON, Mobility functionalities. The femto cell system comprises of the layer 2 devices, where the layer 2 device is configured for establishing a connection with the Layer 3 device that it is configured on being powered and operating on the resources allocated by the Layer 3 device. The layer 2 device functions independently of the layer 3 device. The Layer 3 device further comprises a database that stores information on the Layer 2 devices that are in its vicinity. The Layer 3 device checks for the configured parameters where the parameters include at least one of allocated cell id, primary scrambling code, physical cell id, frequency of operation, plmn, frequency of operation within femto cluster depending upon the technology—WCDMA or LTE. The Layer 3 device further defines parameters for the Layer 2 devices that include at least one of band of operation, frequency of operation, cell id, plmn, physical cell id, default power of each physical cell of operation, neighbor list. The Layer 3 devices is further configured for determining if a fake Layer 2 devices is connected to the network, if fake Layer 2 is connected, handover users to other Layer 2 devices connected in the network and removing the fake Layer 2 device out of the network. The Layer 3 device allocates resources to the Layer 2 devices based on parameters that include at least one of physical location of the Layer 2 device, coverage provided, number of users connected to the Layer 3. The Layer 3 device further allocates optimum power to be used by the Layer 2 devices, where the optimum power is decided on one of addition of new Layer 2 devices, removal of Layer 2 devices, current SINR, load on entire cluster. A layer 3 device hides the topology of Layer 2 devices and acts as the signaling anchor and interfaces with Core network. Layer 3 will do neighbor list discovery either by way of configuration or by way of employing monitoring capability.

Embodiments herein also disclose a Layer 3 device in a femto cell. The Layer 3 device configured for checking if a Layer 2 device that is in its vicinity has the parameters configured, configuring Common Radio Resource, SON, Transport Resource power control parameters of the Layer 2 device and allocation of dedicated radio resources to the Layer 2 device based on the Common Radio Resource, Transport resource, power control parameters as and when new radio connections are needed. The Layer 3 device further comprises a database that stores information on the Layer 2 devices that are in its vicinity. The Layer 3 device checks for the configured parameters where the parameters include at least one of allocated cell id, primary scrambling code, physical cell id, frequency of operation, plmn, frequency of operation within femto cluster. The Layer 3 device further defines parameters for the Layer 2 devices that include at least one of band of operation, frequency of operation, cell id, plmn, physical cell id, default power of each physical cell of operation, neighbor list. The Layer 3 device is further configured for determining if a fake Layer 2 device is connected to the network, if fake Layer 2 is connected, handover users to other Layer 2 devices connected in the network and removing the fake Layer 2 device out of the network. The Layer 3 device allocates resources to the Layer 2 devices based on parameters that include at least one of physical location of the Layer 2 device, coverage provided, number of users connected to the Layer 3. The Layer 3 device further allocates maximum power to be used by the Layer 2 devices, where the maximum power is decided on one of addition of new Layer 2 devices, removal of Layer 2 devices, current SINR, load on entire cluster.

Embodiments herein also disclose a Layer 2 device in a femto cell. The Layer 2 device configured for establishing a connection with a Layer 3 device that it is configured on being powered and operating on the resources allocated by the Layer 3 device. The Layer 2 device further establishes connection with the Layer 3 device to learn about parameters like band of operation, frequency of operation, cell id, plmn, physical cell id, default power of each physical cell of operation, neighbor list.

Also, disclosed herein is a method for processing in a Femto cell. The femto cell comprising at least one Layer 3 device, at least one Layer 2 device, operators network, further the method comprising the layer 3 device processing the layer 3 and the layer 2 device processing the layer 2, where the layer 2 device functions independently of the layer 3 device. The method employs the layer 3 device for checking if a Layer 2 device that is in its vicinity has the parameters configured, configuring Common Radio Resource, SON, Transport Resource power control parameters of the Layer 2 device and allocation of dedicated radio resources to the Layer 2 device based on said Common Radio Resource, Transport resource, power control parameters as and when new radio connections are needed. The method employs the layer 2 device for establishing a connection with the Layer 3 device that it is configured for on being powered and operating on the resources allocated by the Layer 3 device. The method further comprises a database in the Layer 3 device and the database stores information on Layer 2 devices that are in its vicinity. The method further checks for the configured parameters where the parameters include at least one of allocated cell id, primary scrambling code, physical cell id, frequency of operation, plmn, frequency of operation within femto cluster. The method further defines parameters for the Layer 2 devices that include at least one of band of operation, frequency of operation, cell id, plmn, physical cell id, default power of each physical cell of operation, neighbor list. The method as in claim 20, wherein the method further comprises of determining if a fake Layer 2 device is connected to the network, if fake Layer 2 is connected, handover users to other Layer 2 devices connected in the network and removing the fake Layer 2 device out of the network. The method further allocates resources to the Layer 2 devices based on parameters that include at least one of physical location of the Layer 2 device, coverage provided, number of users connected to the Layer 3. The method further allocates maximum power to be used by the Layer 2 devices, where the maximum power is decided on one of addition of new Layer 2 devices, removal of L2 devices, current SINR, load on entire cluster.

These and other aspects of the embodiments herein will be better appreciated and understood when considered in conjunction with the following description and the accompanying drawings.

### BRIEF DESCRIPTION OF THE FIGURES

The embodiments herein will be better understood from the following detailed description with reference to the drawings, in which:

FIG. 1 illustrates a general block diagram of the proposed architecture as disclosed herein;

FIG. 2 illustrates the proposed architecture with distributed L2 device as disclosed herein;

FIG. 3 illustrates block diagram of the proposed L3 device architecture and its components as disclosed herein;

FIG. 4 illustrates block diagram of the proposed L2 device architecture and its components as disclosed herein;

FIG. 5 illustrates a Femto cluster architecture for a WCDMA system and its components as disclosed herein;

FIG. 6 illustrates a Femto cluster architecture for a LTE system and its components as disclosed herein;

FIG. 7 illustrates a flow diagram which describes the process of performing scaling with ease as disclosed herein;

FIG. 8 illustrates a flow diagram which describes the process of implementing a fast path so as to make the system flexible as disclosed herein;

FIG. 9 illustrates a flow diagram which describes the process of providing location based services as disclosed herein;

FIG. 10 illustrates a flow diagram which describes the process of sniffing and traffic shaping as disclosed herein; and

FIG. 11 illustrates a flow diagram which describes the process of L3 device managing L2 device as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

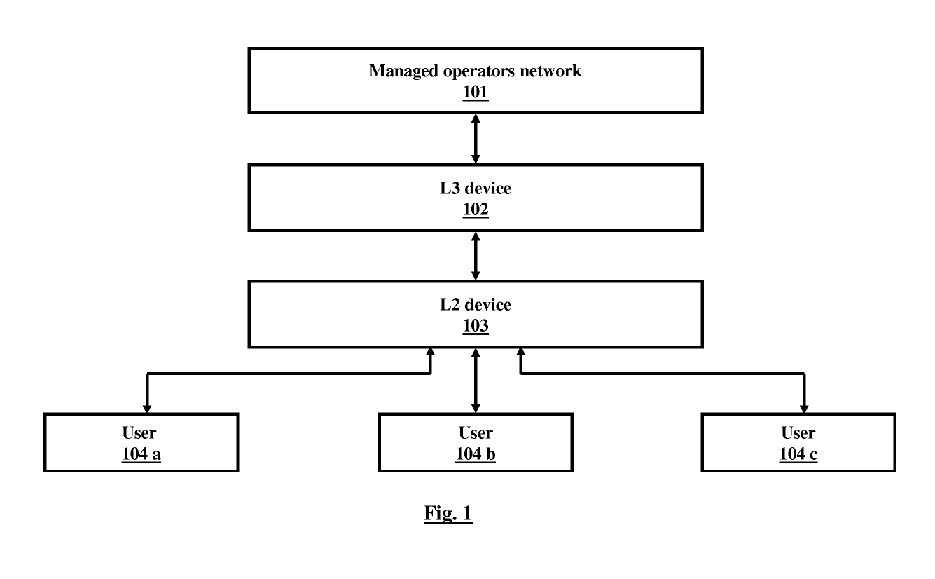

The embodiments herein disclose a method of eliminating congestion between L2 and L3 layers by providing separate hardware for L2 and L3 layers. Referring now to the drawings, and more particularly to FIGS. 1 through 11, where similar reference characters denote corresponding features consistently throughout the figures, there are shown embodiments.

### Definitions

PDCP: PDCP stands for Packet Data Convergence Protocol. It is one of the layers of Radio Traffic Stack in UMTS and performs operations like IP header compression and decompression, transfer of user data and maintenance of sequence numbers for Radio bearers which are configured for lossless serving radio network subsystem (SRNS) relocation.

GTP/RTP: GTP stands for GPRS Tunneling Protocol. It is a group of IP based communication protocols used to carry General Packet Radio Service (GPRS) within GSM and UMTS networks. Similarly, RTP stands for Real-Time Transport protocol and it defines a standardized packet format for delivering audio and video over the IP network.

L2AP: L2AP stands for Layer 2 Application Part. The functions of L2AP are managing setup/modify/release procedures for L1 and L3-L2 interfaces and also working as an L1 and L3-L2 measurement interface.

RLC: RLC stands for Radio Link Control protocol which is used in wireless network interfaces in order to bring down the packet loss especially in voice networks.

UDP: UDP stands for User Datagram Protocol. UDP is a member of Internet protocol suite which helps computer applications send messages/datagram to other hosts on an IP network without requiring prior communications to set up special transmission channels or data paths.

SCTP: SCTP stands for Stream Control Transmission Protocol. It is a message oriented protocol that ensures reliable, in sequence transport of messages with congestion control.

MAC: MAC stands for Media Access Control. It is a sub layer of data link layer and provides addressing and channel access control mechanisms which allow several terminals or network nodes to communicate within a multi-point network.

PHY: PHY stands for Physical Layer in a communication network. PHY connects data link layer to a physical medium such as an optical fiber or copper cable.

IP: IP stands for Internet Protocol. It is the principle communications protocol used for relaying data packets across the internetwork using IP protocol suite.

RRM: RRM stands for Radio Resource Management. Radio Resource Management (RRM) unit. RRM instructs the user to use multiple radio links to better serve cell edge performance.

SON: SON stands for Self Organizing Networks. Each L3 device 102 controls multiple L2 devices 103. All the L3 devices 102 present in the network are connected to a central L3 device 102 through one to one (e)L2AP connection. This L3 device 102 acts as a central server and maintains a database containing information related to L2 device 103 parameters. L3 being the central device, is aware of all the system parameters associated with each of the associated L2 device 103 and hence is capable of distributing parameters to L2 devices 103 uniquely.

Mobility: The H(e)NB device also offers better mobility services. Here, the L3 device 102 can forward location based services and advertisements to a user without being triggered by a location based server when the user move from one location to another. L3 acts as the anchor for all L2 devices for handovers without involving the Core network. Thus, it decreases the signaling load in the core network.

HNBAP: HNBAP protocol enables highly scalable ad-hoc HNB deployment.

RANAP: RANAP stands for Radio Access Network Application Part and is used in UMTS signaling between the core networks. It is carried over the lu-interface.

RUA: RUA stands for RANAP User Adaptation protocol and is used to carry the RANAP signaling over the IP based lu-interface.

RRC: RRC stands for Radio Resource Control Protocol. It belongs to the UMTS WCDMA and LTE protocol stack and handles the control plane signaling of Layer 3 between user equipments and (E-)UTRAN (Enhanced UMTS terrestrial radio access network).

SUA: SUA stands for SCCP User Adaptation protocol. It replaces the functionality of SCCP and M3UA over SCTP in an IP network.

X2AP: X2AP stands for X2 application protocol. X2AP handle the user equipment mobility within EUTRAN and provides various services including mobility management, load management and so on.

S1AP: S1AP stands for S1 Application Protocol. The function of S1AP is to provide signaling service between E-UTRAN and evolved packet core.

eL2AP: eL2AP stands for enhanced Layer 2 Application Part to be used in LTE network. The functions of eL2AP are managing setup/modify/release procedures for L1 and L3-L2 interfaces and also working as an L1 and L3-L2 measurement interface.

FIG. 1 illustrates a general block diagram of the proposed architecture as disclosed herein. The system comprises a managed operator's network 101, L3 layer devices 102, L2 layer device 103 and plurality of users 104a, 104b and 104c.

The system described herein implements separate L2 layer device 103 and L3 layer device 102 between user 104 and the network 101. The communications between network 101 and user 102 take place through L2 layer 103 and L3 layer 102. L2 layer 103 and L3 layer 102 are implemented in separate hardware. Further, the connection between the L2 and L3 devices is made in such a way that each L2 device 103 is connected with each L3 device 102 via different connections. The advantage of this method is that when a particular channel is busy, the devices can use an alternate channel for communication. Also, there is a limit to the number of devices that can be supported by L2 layer devices 103. So more devices are to be supported by making use of distributed L2 layer architecture. Further, Layer 3 devices are controlling the RRM, SON, mobility, Power Control, Interference Management and so on, direct data path from Layer 2 to data gateway.

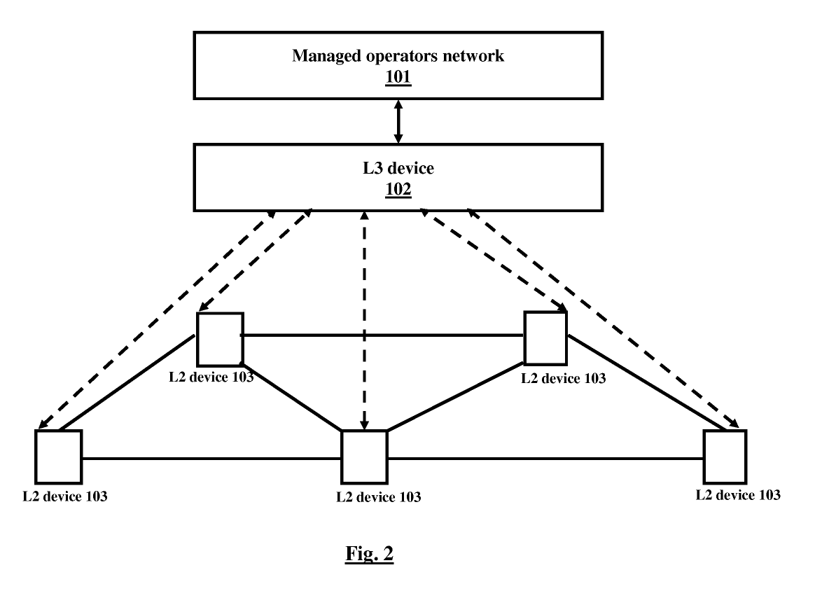

FIG. 2 illustrates the proposed architecture with distributed L2 device 103 forming mesh architecture as disclosed herein. The system comprises managed operators network 101, L3 device 102 and multiple L2 devices 103.

The operator's network 101 communicates with L3 device 102 which inturn communicates with the associated L2 device 103 and vice versa. The system described herein uses distributed architecture for L2 device 103 where multiple L2 device 103 are connected to a single L3 unit via separate channel and are controlled accordingly. The multiple L2 devices 103 which are connected to a single L3 device 102 have interconnection between them forming a mesh network. Each of these L2 device 103 are connected to the L3 device 102 via separate channel so that the communication between L3 device 102 and multiple L2 device 103 can be done simultaneously without causing congestion in the network.

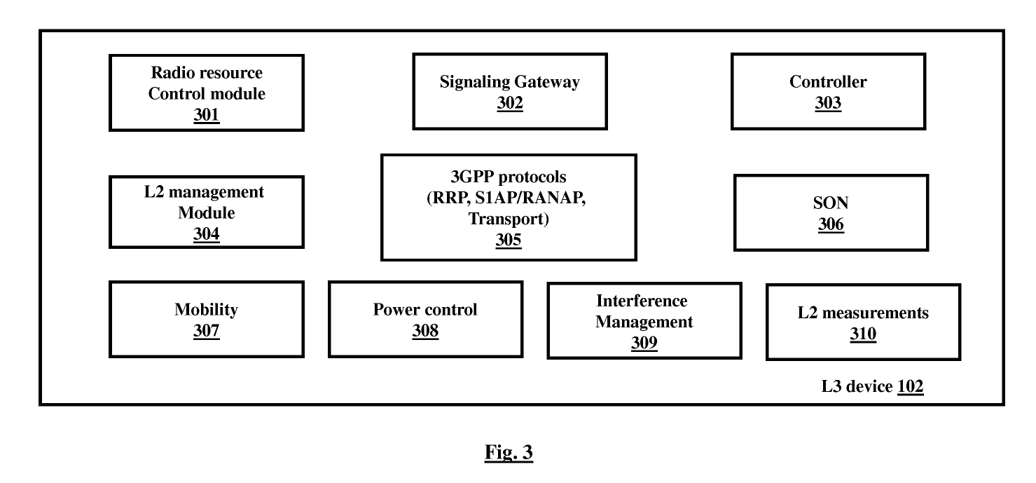

FIG. 3 illustrates block diagram of the proposed L3 device 102 architecture and its components as disclosed herein. The system comprises a radio resource control module 301, gateway 302, controller 303, L2 management module 304, 3GPP protocols 305, SON 306, Mobility 307, Power control 308, Interference management 309 and L2 measurements 310.

The radio resource control module 301 is for controlling various operations like connection, establishment and release, broadcast of system information, paging notification and release, outer loop power control, RRC connection mobility procedures, radio bearer establishment/reconfiguration and release etc. The gateway 302 provides an entry/exit point to the system. Further, a controller 303 is provided with the system so as to control various operations being performed by the L3 device 102. A L2 management module 304 is provided which is used for controlling the L2 device 103 associated with each L3 device 102.

The 3^{rd} Generation Partnership program (3GPP) protocols associated with the L3 device 102 are RRP, S1AP/RANAP and transport protocols. S1AP stands for S1 Application Protocol. The function of S1AP is to provide signaling service between E-UTRAN and evolved packet core. RANAP stands for Radio Access Network Application Part and is used in UMTS signaling between the core networks. It is carried over the lu-interface. The transport protocol defines standardized packet format for delivering audio and video over the IP networks.

SON module 306 stands for Self Organizing Networks module. This functionality is associated with the proposed system. Each L3 device 102 controls multiple L2 devices 103. All the L3 devices 102 present in the network are connected to a central L3 device 102 through one to one (e) L2AP connection. This L3 device 102 acts as a central server and maintains a database containing information related to L2 device 103 parameters. L3 being the central device, is aware of all the system parameters associated with each of the associated L2 device 103 and hence is capable of distributing parameters to L2 devices 103 uniquely. This module handles the local SON management for L2 devices.

The Mobility module 307 is achieved using a Radio Resource Management (RRM) entity. RRM instruct the user to use multiple radio links which can be later added or deleted as the user moves over a geographical area without losing connectivity and data.

Power control module 308 present within the system is managed by L3 device 102. L3 device 102 being the centralized unit shall configure each L2 unit 103′s power control parameter. L3 device 102 can manage and propagate power control parameters as configured by OAM to all L2 devices 103. By making use of positioning measurements and outer loop power control feedback from L2Pus, L3 device 102 calculates power to be used by each L2 device 103 and uses of its neighbors.

Interference management module 309 is present in the system which effectively manages interference in the deployed environment. In the system, L3 is the centralized node and is aware of the parameters associated with each L2 device 103.

Being aware of associated L2 device parameters will help L3 device 102 to manage interference within the system effectively.

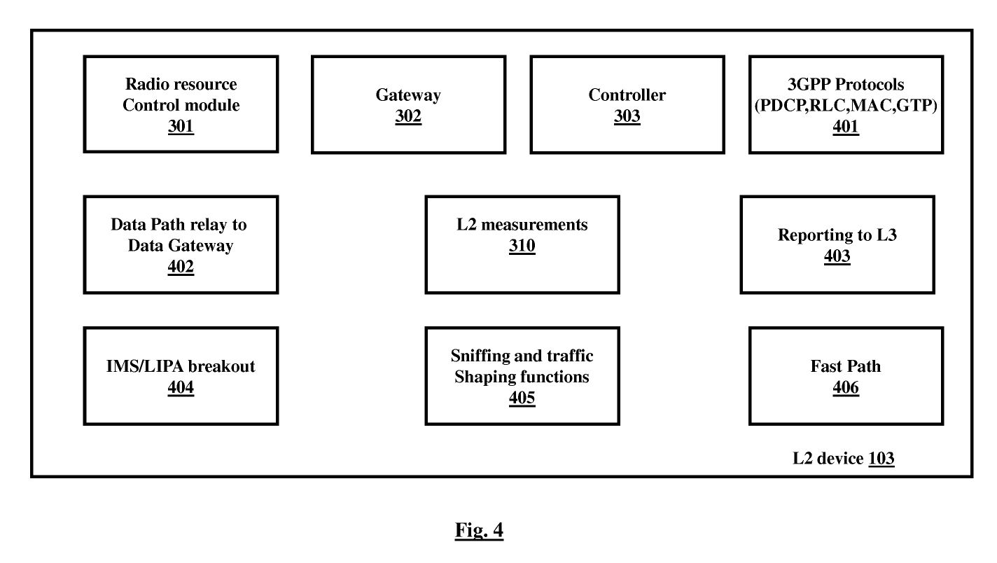

FIG. 4 illustrates block diagram of the proposed L2 device 103 architecture and its components as disclosed herein. The system comprises a radio resource control module 301, a gateway 302, a controller 303, 3GPP protocols module 401, Data path relay to Data Gateway module 402, L2 measurements module 310, Reporting to L3 module 403, IMS/LIPA breakout module 404, Sniffing and traffic shaping module and a fast path module 406.

The radio resource control module 301 is for controlling various operations like connection establishment and release, broadcast of system information, paging notification and release, outer loop power control, RRC connection mobility procedures, radio bearer establishment/reconfiguration and release etc. The gateway 302 provides an entry/exit point to the system. Further, a controller 303 is provided with the system so as to control various operations being performed by the L2 device 103.

The 3GPP protocols associated with the system are PDCP, RLC, MAC and GTP. PDCP stands for Packet Data Convergence Protocol. It is one of the layers of Radio

Traffic Stack in UMTS and performs operations like IP header compression and decompression, transfer of user data and maintenance of sequence numbers for Radio bearers which are configured for lossless serving radio network subsystem (SRNS) relocation. RLC stands for Radio Link Control protocol which is used in wireless network interfaces in order to bring down the packet loss especially in voice networks. MAC stands for Media Access Control. It is a sub layer of data link layer and provides addressing and channel access control mechanisms which allow several terminals or network nodes to communicate within a multi-point network. GTP stands for GPRS Tunneling Protocol. It is a group of IP based communication protocols used to carry General Packet Radio Service (GPRS) within GSM and UMTS networks.

The data path relay to data gateway module 402 implies a separate data connection using which the data transfer take place between L2 devices and the gateway.

Reporting to L3 module 403 present in the system is used to report the congestion and overload happening in the system as a result of data transfer in the L2 devices 103. L2 also reports physical Layer measurements as directed by L3 such as Power and Interference.

IMS/LIPA breakout module 404 is present within the system. IMS stands for IP Multimedia Subsystem. IMS is an architectural frame work for delivering Internet Protocol (IP) multimedia services. In this architecture, L3 sets up the data path for IMS/LIPA traffic not to be routed through the 3GPP Core network. LIPA/IMS traffic directly goes to the Internet/Intranet.

Sniffing and Traffic shaping functions module 405 present within the system help the network operators incorporate traffic monitoring and shaping functionalities. Use of separate control and data paths help the operators to monitor control and data flow separately. Monitoring of traffic control is important to facilitate admission control, congestion control, statistics collection and QoS control along with policy enforcement. The proposed architecture provides flexibility by offering a way to monitor data and control flows separately. Another advantage of this method is that actions performed on one node will not affect other node.

The use of separate data and control path in the proposed system will facilitate faster data transfer without affecting control data flow. Deployment can choose to use an operating system with very constrained functionalities but enough for running L2. This implementation will help to reach theoretical maximum limit of system performance.

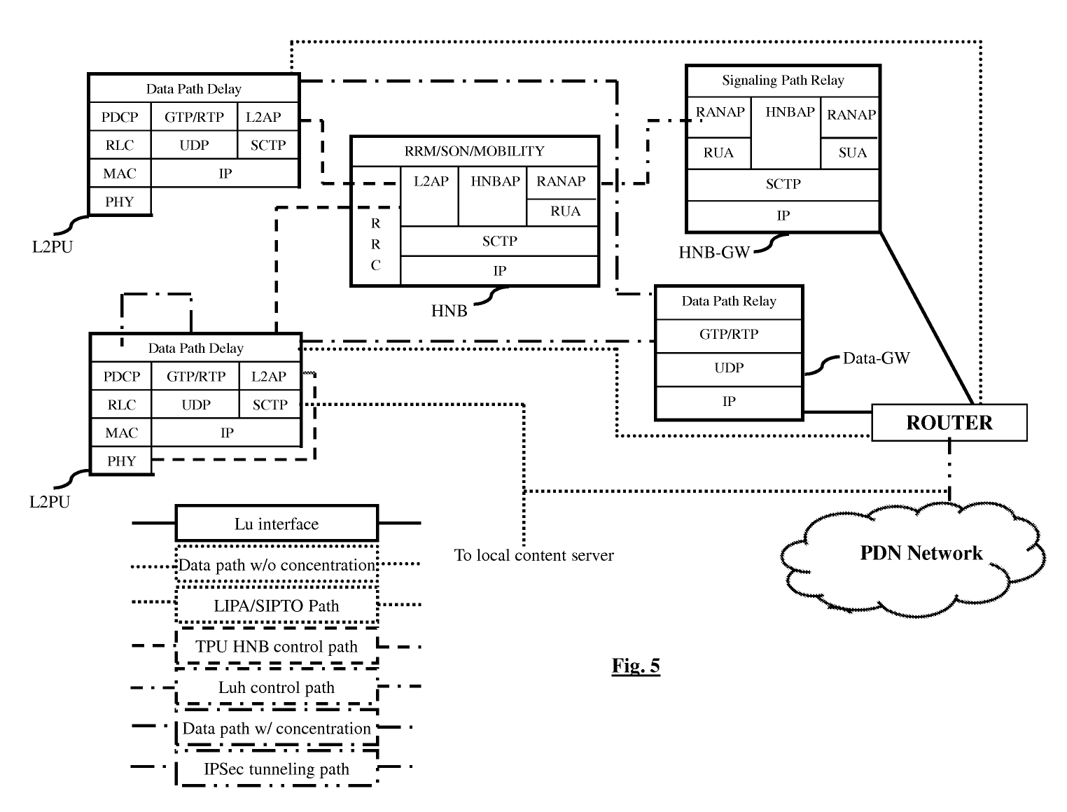

FIG. 5 illustrates Femto cluster architecture for WCDMA system and its components as disclosed herein. The architecture comprises a PDN network, a Home NodeB gateway (HNB-GW), a Data gateway (Data-GW), router and L2 processing units (L2PU).

Router connects the L2 processing units with the network via the home node gateways (HNB-GW) and the Home NodeB devices. Separate connections are assigned for control and data flow so that transfer of control signals and data signals can take place without interfering each others flow. The data gateway (Data-GW) takes care of data flow in the network and the Home NodeB gateway (HNB-GW) takes care of control flow in the system. Various functions including Self Organizing Network (SON), Radio Resource Management (RRM), mobility management functions, power control functions, Operations Administrations and maintenance (OAM) interface and so on are managed by the Home NodeB gateways. Home NodeB act as a central server distributing various configuration parameters to L2 upon request. Two planes are present in the architecture namely control plane and data plane. Control plane is referred to as HNB and the data plane is referred to as L2PU. HNB controls multiple L2Pu's and each L2PU provides L1 and L2 interface for one cell while the control plane is hosted centrally in the HNBs.

The components of HNB-GW are RANAP, RUA, HNBAP, SUA, SCTP and IP along with the Signaling path relay.

The components of data-GW present in the network are GTP/RTP, UDP and IP along with the data path relay.

The components of HNB device are RRC, L2AP, HNBAP, RANAP, RUA, SCTP and IP. HNB also provides services like RRM, SON and mobility.

The components of L2PU devices are protocols like PDCP, GTP/RTP, RLC, UDP, SCTP, IP and hardware components like MAC, PHY and L2AP along with data path relay.

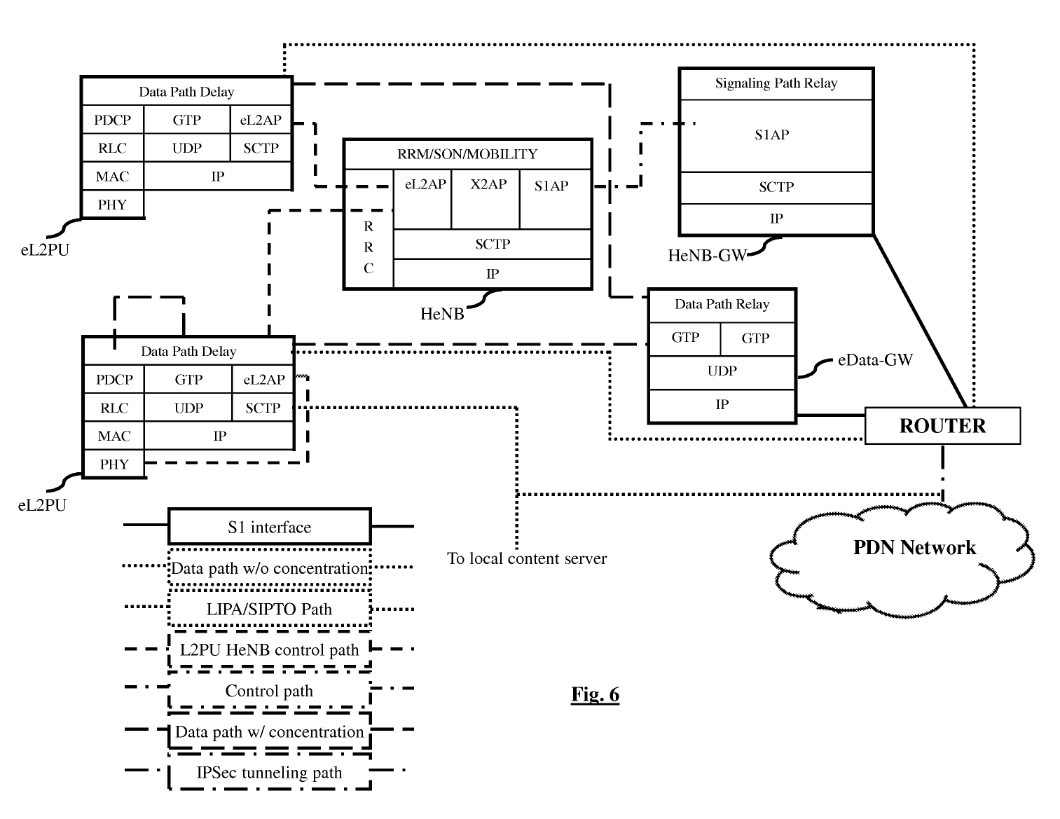

FIG. 6 illustrates a Femto cluster architecture for LTE system and its components as disclosed herein. The architecture comprises a PDN network, a Home eNodeB gateway (HeNB-GW), a Data gateway (eData-GW), router and L2 processing units (eL2PU).

Router connects the L2 processing units with the network via the home eNodeB gateways (HeNB-GW) and the Home eNodeB (HeNB) devices. Separate channels are assigned for control and data flow so that transfer of control signals and data signals can take place without interfering each others flow. The data gateway (eData-GW) takes care of data flow in the network and the Home eNodeB gateway (HeNB-GW) takes care of control flow in the system. Various functions including Self Organizing Network (SON), Radio Resource Management (RRM), mobility management functions, power control functions, Operations Administrations and maintenance (OAM) interface and so on are managed by the Home eNodeB gateways (HeNB-GW). Home eNodeB (HeNB) act as a central server distributing various configuration parameters to L2 upon request. Two planes are present in the architecture namely control plane and data plane. Control plane is referred to as HeNB and the data plane is referred to as eL2PU. HeNB controls multiple eL2PU's and each eL2PU provides L1 and L2 interface for one cell while the control plane is hosted centrally in the HeNB.

The components of HeNB gateway (HeNB-GW) are S1AP, SCTP and IP along with the signaling path relay.

The components of data gateway (eData-GW) are GTP/RTP, UDP and IP along with the signaling path relay.

The components of HeNB are RRC, eL2AP, X2AP, S1AP, SCTP and IP. HeNB also provide functionalities like RRM, SON and mobility services.

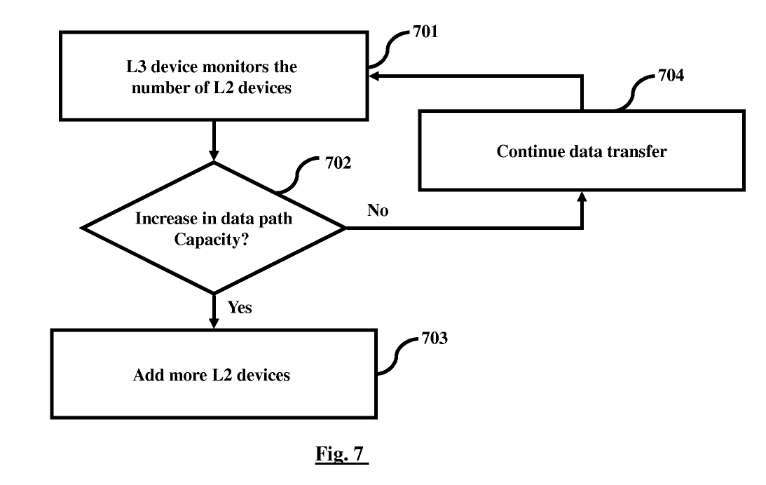

FIG. 7 illustrates a flow diagram which describes the process of performing scaling with ease as disclosed herein. During this process, L3 device continuously monitors (701) the number of L2 devices associated with the system. Then the system checks (702) if the data path capacity has exceeded the maximum limit or not. If the maximum data path capacity is found to be exceeded, more L2 devices are added to the system. If the data path capacity usage is found to be within the limit, the system continues (704) the data transfer via the available channels until the maximum data path capacity is found to be used by the system. The various actions in method 700 may be performed in the order presented, in a different order or simultaneously. Further, in some embodiments, some actions listed in FIG. 7 may be omitted.

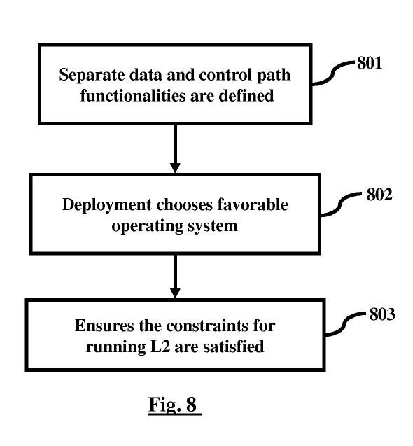

FIG. 8 illustrates a flow diagram which describes the process of implementing a fast path so as to make the system flexible as disclosed herein. The system employs (801) separate data and control path for the transfer of data and control signals respectively in the system. Deployment chooses (802) a favorable operating system and ensures (803) the constraints for running L2 are satisfied. The various actions in method 800 may be performed in the order presented, in a different order or simultaneously. Further, in some embodiments, some actions listed in FIG. 8 may be omitted.

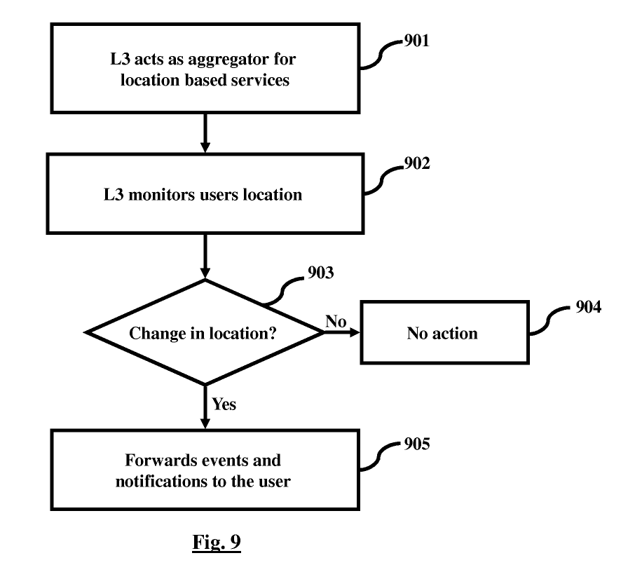

FIG. 9 illustrates a flow diagram which describes the process of providing location based services as disclosed herein. L3 act as (901) an aggregator for location based services and continuously monitor (902) user's position. Along with monitoring the position of user, the system checks (903) if the user's location has changed or not. If the user location is found to be same, the system does not perform any action (904). If the user location is found to be changed, the system forwards (905) location based events and notifications to the user without being triggered by any location server. The various actions in method 900 may be performed in the order presented, in a different order or simultaneously. Further, in some embodiments, some actions listed in FIG. 9 may be omitted.

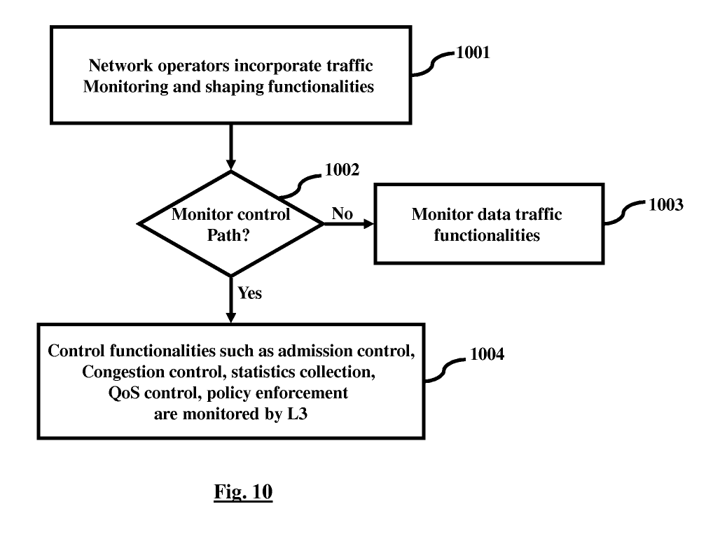

FIG. 10 illustrates a flow diagram which describes the process of sniffing and traffic shaping as disclosed herein. The network operators incorporate (1001) traffic monitoring and shaping functionalities in order to enforce self defined policies or the policies defined by authorities. Data and control flows are monitored separately by the system using separate data and control paths. The system then checks (1002) if the control path is to be monitored or not. If not, the data traffic functionalities are monitored (1003) by the system. If the network provider needs to monitor traffic to run admission control, congestion control, statistics collection, QoS control, policy enforcement it can be done by monitoring (1004) the traffic at L3 layer entity. The various actions in method 1000 may be performed in the order presented, in a different order or simultaneously. Further, in some embodiments, some actions listed in FIG. 10 may be omitted.

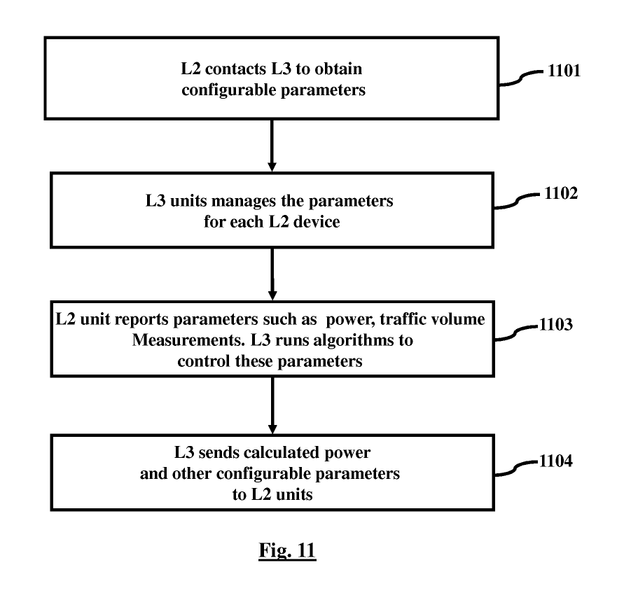

FIG. 11 illustrates a flow diagram which describes the process of L3 device 102 managing L2 device 103 as disclosed herein. Initially L2 device 103 contacts (1101) corresponding L3 device 102 in order to obtain the configurable parameters. The configurable parameters comprises band, frequency of operation, cell id, physical cell id, default power for each physical channel of operation, neighbor list etc. Upon reception of request from L2 device 103, L3 device 102 manages (1102) parameters corresponding to each L2 device 103. This is because the L2 device is configured with parameters for all the cells that it is going to manage. L3 locally manages all configurations. This is done initially, as well as dynamically. L2 reports the power, traffic volume measurements. L3 runs algorithms to control those parameters. The L3 device 102 calculates (1103) power corresponding to each L2 device 103 and its neighbors. In order to calculate power for each L2 device 103, L3 device 102 makes use of positional measurements and outer loop power control feedback from L2 processing units. Along with theses parameters, L3 device 102 units also consider the physical location and coverage of L2 units 103 so as to dimension and allocate the maximum power to be used by an L2 unit 103. Then L3 device 102 sends (1104) the calculated power and other parameters to corresponding L2 device 103. The various actions in method 1100 may be performed in the order presented, in a different order or simultaneously. Further, in some embodiments, some actions listed in FIG. 11 may be omitted.

In the embodiments disclosed herein, the L3 layer device is provided with hybrid SON capacity, Radio Resource Management (RRM), Location based Services (LCS) and the like so as to provide the system features like mobility, LIPA/SIPTO (Selective IP traffic Overload), scaling etc.

The proposed cluster architecture meets hybrid Self Optimizing capabilities (SON) defined by the 3rd generation partnership program (3GPP) without requiring SON to be implemented in each device. The system is designed in such a way that a single L3 device 102 handles multiple L2 units 103. So the number of L3 units 102 will be less as compared to the number of L2 units 103. Since the SON servers has to control only the L3 device 102, the reduction in number of L3 units 102 will correspondingly reduce the load on SON server. L3 device 102 is having a data base which contains details regarding parameters of every L2 device 103 connected to the L3 device 102. When a L2 device 103 contacts the L3 device 102 in order to get the configurable parameters, L3 device 102 fetches the parameters from the data base and allocates to the L2 device 103 along with the calculated power for that particular L2 device 103. Since L3 device 102 is the centralized node, it is aware of already allocated parameters and hence assures allocation of most unique and non interfering values of parameters including frequency of operation, default power etc.

Radio resource management in the embodiments disclosed herein is quite simple as L3 device 102 will be aware of traffic in each L2 device 103 by using traffic volume measurements. Using this information, L3 device 102 can manage traffic in the network and can control multiple L2 devices 103 to overcome an overload situation.

The embodiments disclosed herein are designed in such a way that when a user moves from one location to another, L3 device 102 can forward events and services suitable for the new location. In this system, L3 device 102 does not have to be triggered by the Location based service server to provide these services. This inturn reduces signaling overhead and latency in the backhaul and also ensures delivery of location based services to the user in real time.

The embodiments disclosed herein ensure ease of mobility within the deployed network. This is done by controlling all the cells using a single Radio Resource Management (RRM) unit. RRM instructs the user to use multiple radio links to better serve cell edge performance. Radio links can be added or deleted as user moves over a geographical area without losing connectivity and data and without support of RNSAP. In this architecture, all hard handovers need not be SRNS relocation and RRM & RRC are single entity for a Femto cluster. L3 RRM can decide signal and complete hard handover without involving core network within a Femto cluster. In order to support this, the source cell RRC context shall send the SRNS relocation context directly to target cell RRC context without involving the CN. It will not require any change in the protocols. Only the change in procedure will be sufficient.

The embodiments disclosed herein also enable localized QoS control. In this system, since signaling path is aggregated, L3 device 102 is aware of all traffic bearers. Hence L3 device 102 can take decision to allow/reject/modify the bearer QoS and maximum data rate during the call admission control. If the backhaul gets loaded after the calls have been admitted, L3 device 102 compensates this by reducing QoS of bearers or even by releasing some of the bearers.

The embodiments disclosed herein also provide separate control and data path lines for communication. The separation of L2 device 103 and L3 device 102 into discrete nodes allows equipment provider meet different requirements of L2 and L3 processing. L2 device 103 is traffic intensive and has real time timing requirements. For example, L2 PDCP, RLC and MAC needs to compress the IP header for each IP payload, segment the required size of pdu, append headers, cipher and send required number of pdus to L1 per transmission time interval in the downlink. These functions are performed in reverse order in the uplink by L2 device 103. The functions performed by L3 device 102 include handling incoming UE requests, running call admission control, taking decision on bearer QoS, configuration and reconfiguration of radio bearers and incoming request from core network etc. L2 device 103 makes use of a real time OS as timing requirements are strict in L2 device 103.

In this architecture, since L3 device 102 functionality is separated on a different physical entity, normal data processing like RLC ARQ, segmentation/reassembly, ciphering/deciphering, header compression/decompression etc is not compromised when L3 device 102 need to run complex algorithms for call admission control and admission control. It also gives flexibility in choosing L2 device 103 specific hardware. Also, separate L3 device 102 and L2 device 103 architectures gives flexibility of choosing cheaper, single core architectures.

The system of using different hardware for L2 device 103 and L3 device 102 eases the process of scaling. The increase in number of users each year demands scaling of the system. The proposed architecture provides flexibility of scaling control path and data path separately. When data path reaches its maximum capacity, more number of L2 devices 103 can be added without adding or upgrading new L3 boxes.

Another advantage of using a system of distributed L2 device 103 and L3 device 102 architectures is that the system can support multiple vendors. In such a system, since each node is controlled separately by a common RRM unit, operator doesn't have to worry about the control algorithms used in the nodes.

Since the system is using separate data and control path implementation, fast path implementation of data path can be done without affecting the control path, thus making the system capable of using reaching maximum limit of theoretical system performance.

This architecture proposes Local IP breakout path from the L2 entities. Again, L2 processing for Local IP breakout is not compromised by control path processing.

The architecture gives a possibility of having a multimode architecture, providing flexibility to the network provider to do a completely new multiple RAN architecture by combining L2 units 103 and L3 units 102 of UMTS and LTE.

Further, the architecture proposes, each HNB or L2PU shall not have an IPSec tunnel towards the HNB-GW. In the case of the proposed architecture, an assumption is made that cluster network will be managed by a single party and hence it is not necessary to secure all the legs. Only one tunnel from router is needed where all HNBs and data gateways terminate thereby reducing latency and improving data rate within the cluster network. This inturn reduces IPSec tunnel management overhead in each Femto unit.

Another advantage of the proposed architecture is that network provider gets the flexibility of monitoring control and data traffic separately. If the network provider wants to monitor traffic to run admission control, congestion control, statistic collection, QoS control, policy enforcement, he can monitor the traffic at L3 entity thereby providing flexibility. Also, separation of L2 devices 103 and L3 device 102 does not affect each other and does not mandate upgrade of processing power in all nodes, if one node decides to implement or upgrade policies.

The embodiments disclosed herein can be implemented through at least one software program running on at least one hardware device and performing network management functions to control the network elements. The network elements shown in FIGS. 1, 2, 3 and 4 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A femto cell system comprising:
at least one layer 3 device; and
at least one layer 2 device.

2. The femto cell system as in claim 1, wherein said system comprises of said layer 3 device, where said layer 3 device is configured for:
checking if said Layer 2 device that is in its vicinity has the parameters configured;
configuring at least one of Common Radio Resource, SON, Transport Resource power control parameters of said Layer 2 device; and
allocation of dedicated radio resources to said Layer 2 device based on said Common Radio Resource, Transport resource, power control parameters as and when new radio connections are needed.

3. The femto cell system as in claim 1, wherein said system comprises of said layer 2 device, where said layer 2 device is configured for:
establishing a connection with said Layer 3 device that it is configured on being powered; and
operating on said resources allocated by said Layer 3 device.

4. The femto cell system as in claim 1, wherein said layer 2 device functions independently of said layer 3 device.

5. The femto cell system as in claim 1, wherein said Layer 3 device further comprises a database that stores information on said Layer 2 devices that are in its vicinity.

6. The femto cell system as in claim 2, wherein said Layer 3 device checks for said configured parameters where said parameters include at least one of allocated cell id, primary scrambling code, physical cell id, frequency of operation, plmn, frequency of operation within femto cluster depending on the technology.

7. The femto cell system as in claim 2, wherein said Layer 3 device further defines parameters for said Layer 2 devices that include at least one of band of operation, frequency of operation, cell id, plmn, physical cell id, default power of each physical cell of operation, neighbor list.

8. The femto cell system as in claim 2, wherein said Layer 3 devices is further configured for:
determining if a fake Layer 2 devices is connected to the network;
if said fake Layer 2 device is connected, handover users to other Layer 2 devices connected in the network; and
removing said fake Layer 2 device out of said network.

9. The femto cell system as in claim 2, wherein said Layer 3 device allocates resources to said Layer 2 devices based on parameters that include at least one of physical location of said Layer 2 device, coverage provided, number of users connected to said Layer 3.

10. The femto cell system as in claim 2, wherein said Layer 3 device further allocates maximum power to be used by said Layer 2 devices, where said maximum power is decided on one of addition of new Layer 2 devices, removal of Layer 2 devices, current SINR, load on entire cluster.

11. A Layer 3 device in a femto cell, said Layer 3 device configured for:
checking if a Layer 2 device that is in its vicinity has the parameters configured;
hosting functionalities of said Layer 2 device; and
allocation of resources to said Layer 2 device based on said functionalities.

12. The Layer 3 device as in claim 11, where said layer 3 device hosts functionalities where said functionalities comprise at least one of:
control path protocol;
radio resource management;
self optimizing function;
mobility functions;
radio resource control protocol;
luh protocols and luh interface management for WCDMA;
call admission control;
interference management;
power control; and
12 measurement control.

13. The Layer 3 device as in claim 12, where said Layer 3 device further comprises a database that stores information on said Layer 2 devices that are in its vicinity.

14. The Layer 3 device as in claim 12, wherein said Layer 3 device checks for said configured parameters where said parameters include at least one of allocated cell id, primary scrambling code, physical cell id, frequency of operation, plmn, frequency of operation within femto cluster.

15. The Layer 3 device as in claim 12, wherein said Layer 3 device further defines parameters for said Layer 2 devices that include at least one of band of operation, frequency of operation, cell id, plmn, physical cell id, default power of each physical cell of operation, neighbor list.

16. The Layer 3 device as in claim 12, wherein said Layer 3 devices is further configured for:
determining if a fake Layer 2 devices is connected to the network;
if said fake Layer 2 device is connected, handover users to other Layer 2 devices connected in the network; and
removing said fake Layer 2 device out of said network.

17. The Layer 3 device as in claim 12, wherein said Layer 3 device allocates resources to said Layer 2 devices based on parameters that include at least one of physical location of said Layer 2 device, coverage provided, number of users connected to said Layer 3.

18. The Layer 3 device as in claim 12, wherein said Layer 3 device further allocates maximum power to be used by said Layer 2 devices, where said maximum power is decided on one of addition of new Layer 2 devices, removal of Layer 2 devices, current SINR, load on entire cluster.

19. A Layer 2 device in a femto cell, said Layer 2 device configured for:
establishing a connection with a Layer 3 device that it is configured on being powered; and
operating on said resources allocated by said Layer 3 device.

20. The Layer 2 device as in claim 19, wherein said Layer 2 device further establishes connection with said Layer 3 device to learn about parameters like band of operation, frequency of operation, cell id, plmn, physical cell id, default power of each physical cell of operation, neighbor list.

21. The Layer 2 device as in claim 19, wherein said layer 2 device is further configured for hosting functionalities that include at least one of
data path protocols;
ciphering on air interface;
data path relay to local data path concentrator;
network radio monitor;
local Internet Protocol breakout;
internet protocol multimedia subsystem breakout;
selective internet protocol traffic offload;
congestion control;
reporting of said congestion to HNB;
reporting of traffic volumes;
outer loop power control; and
layer 2 measurements.

22. A method for processing in a Femto cell, said femto cell comprising at least one Layer 3 device, at least one Layer 2 device, and an operators network, said method comprising:
said layer 3 device processing said layer 3; and
said layer 2 device processing said layer 2, where said layer 2 device functions independently of said layer 3 device.

23. The method as in claim 22, wherein said method employs said layer 3 device for:
checking if a Layer 2 device that is in its vicinity has the parameters configured;
configuring Common Radio Resource, SON, Transport Resource power control parameters of said Layer 2 device; and
allocation of dedicated radio resources to said Layer 2 device based on said Common Radio Resource, Transport resource, power control parameters as and when new radio connections are needed.

24. The method as in claim 22, wherein said method employs said layer 2 device for:
establishing a connection with said Layer 3 device that it is configured for hosting functionalities on being powered; and
operating on said resources allocated by said Layer 3 device.

25. The method as in claim 22, wherein said method further comprises a database in said Layer 3 device and said database stores information on Layer 2 devices that are in its vicinity.

26. The method as in claim 22, wherein said method further checks for said configured parameters where said parameters include at least one of allocated cell id, primary scrambling code, physical cell id, frequency of operation, plmn, frequency of operation within femto cluster.

27. The method as in claim 22, wherein said method further defines parameters for said Layer 2 devices that include at least one of band of operation, frequency of operation, cell id, plmn, physical cell id, default power of each physical cell of operation, neighbor list.

28. The method as in claim 22, wherein said method further comprises of:
determining if a fake Layer 2 device is connected to the network;
if said fake Layer 2 device is connected, handover users to other Layer 2 devices connected in the network; and
removing said fake Layer 2 device out of said network.

29. The method as in claim 22, wherein said method further allocates resources to said Layer 2 devices based on parameters that include at least one of physical location of said Layer 2 device, coverage provided, number of users connected to said Layer 3.

30. The method as in claim 22, wherein said method further allocates maximum power to be used by said Layer 2 devices, where said maximum power is decided on one of addition of new Layer 2 devices, removal of L2 devices, current SINR, load on entire cluster.
